(19) United States
(12) Patent Application Publication
(10) Pub. No.: US 2006/0098108 A1
(43) Pub. Date: May 11, 2006

(54) Digital camera

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/267,141

(22) Filed: Nov. 7, 2005

(30) Foreign Application Priority Data
Nov. 8, 2004 (JP) 2004-323177

(51) Int. Cl. H04N 9/04

(52) U.S. Cl. 348/272

(57) ABSTRACT

A digital camera including an imaging device, which is adapted to store electric charges for each spectral color of a plurality of spectral colors from an object image and output image signals corresponding to the object image, is provided. The digital camera further includes a storage time controlling system, which is adapted to control length of storage time of the electric charges for each spectral color independently.

### BACKGROUND OF THE INVENTION

The present invention relates to a digital camera capable of executing a color photographing, and particularly to such a digital camera having a white balance adjusting function.

In digital cameras, a color of a captured image may appear different from an original color of the object depending on a type of a light source. For example, a color of a white object photographed under the sun light is different from a color of the object under fluorescent lamp light. Generally, the latter is slightly greener than the former.

In order to avoid the color difference due to a difference of the light source type, a digital camera is typically provided with a white balance sensor. With the white balance sensor, a color of the object, i.e., a color temperature of the object is measured by a color meter, and corresponding to the thus measured color temperature, the color image signal obtained from an image capturing element is processed to adjust the color of the image so that a white object can be captured as a white image. An example of such technique is disclosed in Japanese Patent Provisional Publication No. P2004-193715A. Depending on whether a strobe emits light or not, the white balance is adjusted so that the image of the object shows the object with appropriate colors.

When white balance is adjusted in such digital cameras, gain that is applied to each color component (i.e., RGB: red, green, and blue) obtained from an imaging element is modified. In this technique, however, some of the gain to the color components are required to be increased depending on light sources, and according to the gained values, noise to the color signals may also increase, which may deteriorate the total quality of the image.

In such digital cameras, users are generally allowed to arbitrarily adjust exposure, however, the users are not allowed to arbitrarily adjust the gain for the RGB colors, and the users are allowed to apply a preset white balance to the object image, but not allowed to adjust the white balance arbitrarily. Therefore, images appealing in desired colors may not be obtained. For images that appear in the desired colors, the users are required to modify attributes of color components by using a program, for example photo retouching software, on devices such as personal computers after the image is photographed.

### SUMMARY OF THE INVENTION

Aspects of the present invention are advantageous in that a digital camera capable of imaging an object with appropriate white balances is provided. Other aspects of the present invention are advantageous in that a digital camera capable of allowing a user to arbitrarily adjust white balances to obtain an image in desired colors is provided.

According to some aspects of the present invention, a digital camera including an imaging device, which is adapted to store electric charges for each color component of a plurality of color components from an object image and outputs image signals corresponding to the object image is provided. The digital camera further includes a storage time controlling system, which is adapted to control length of storage time of the electric charges for each color component independently.

Optionally, the plurality of color components may be three primary colors of light.

Optionally, the imaging device may include a plurality of imaging elements. Each of the imaging elements may be adapted to receive each color component respectively. The storage time controlling system may be adapted to control the length of the storage time of the electric charges for each of the imaging elements.

Optionally, the imaging device may be a triple panel imaging device, which includes an optical system to resolve the object image into the plurality of color components. Each of the three imaging elements may be adapted to receive each color component of the resolved plurality of color components.

Optionally, the imaging element may be a charge coupled device.

Optionally, the imaging device may include a plurality of photo receiving cells. Each of the photo receiving cells may include a photo receiving element and a switching element. Each of the photo receiving cells receives each color component. The length of the storage time of the electric charges for each color component is controlled independently by the storage time controlling system.

Optionally, the photo receiving cell may be a metal-oxide semiconductor.

Optionally, the imaging device may include a vertical driving system, which is adapted to select and drive the photo receiving cells that are assigned to each color component. The imaging device may further include a horizontal driving system, which is adapted to obtain the imaging signals corresponding to each color component.

Optionally, the digital camera may include a sensor, which is adapted to evaluate a color temperature of an external light. The storage time controlling system may be adapted to control the length of the storage time of the electric charges for each color component based on the color temperature evaluated by the sensor.

Optionally, the storage time controlling system may be adapted to control the length of the storage time of the electric charges for each color component to be a predetermined length of storage time corresponding to each of a plurality of light sources with different color temperatures.

Optionally, the digital camera may include at least one of a first operating member, which is adapted to specify a color component to be adjusted. The storage time controlling system may be adapted to control the length of the storage time of the electric charges for the color component specified by the first operating member.

Optionally, the digital camera may include a second operating member, which is adapted to set the length of the storage time of the electric charges when the color component to be adjusted is specified by the first operating member.

According to some aspects of the present invention, a digital camera including an imaging device, which is adapted to store electric charges for each color component of a plurality of color components from an object image and outputs image signals corresponding to the object image, is provided. The digital camera further includes a storage time controlling system, which is adapted to arbitrarily control length of storage time of the electric charges for each of the plurality of color components independently based on operations from a user.

Optionally, the digital camera may have at least one of a first operating member, which is adapted to be operated by the user and to specify a color component to be adjusted. The storage time controlling system may be adapted to control the length of the storage time of the electric charges for the color component specified by the first operating member.

Optionally, the digital camera may have a second operating member, which is adapted to be operated by the user and to set the length of the storage time of the electric charges when the color component to be adjusted is specified by the first operating member.

According to some aspects of the present invention, a digital camera including a sensor, which is adapted to obtain a color temperature of an external light, is provided. The digital camera further includes an imaging device, which is adapted to store electric charges for each color component of a plurality of color components from an object image and outputs image signals corresponding to the object image. The digital camera further includes a storage time controlling system, which is adapted to control length of storage time of the electric charges for each of the plurality of color components independently based on the color temperature of the object image obtained from the sensor so that a white balance of the object image is controlled.

According to some aspects of the present invention, a method for using a digital camera having an imaging device is provided. The digital camera is adapted to store electric charges for each color component of a plurality of color components from an object image and output image signals corresponding to the object image, to control length of storage time of the electric charges for each color component independently.

According to some aspects of the present invention, a program product having instructions to use a digital camera including an imaging device is provided. The digital camera is adapted to store electric charges for each color component of a plurality of color components from an object image and output image signals corresponding to the object image, to control length of storage time of the electric charges for each color component independently.

### BRIEF DESCRIPTION OF THE ACCOMPANYING DRAWINGS

FIG. 1 is a perspective view showing a front appearance of a digital camera according to a first embodiment of the present invention.

FIG. 2 is a perspective view showing a rear appearance of the digital camera according to an embodiment of the present invention.

FIG. 3 is a block diagram illustrating an electrical configuration of the digital camera according to the embodiment of the invention.

FIG. 4 is a diagram illustrating a configuration of an imaging device of the digital camera according to the embodiment of the invention.

FIG. 5 is a flowchart illustrating an automatic white balance adjusting operation of the digital camera according to the embodiment of the invention.

FIG. 6 is a flowchart illustrating a preset white balance adjusting operation of the digital camera according to the embodiment of the invention.

FIG. 7 is a flowchart illustrating a manual white balance adjusting operation of the digital camera according to the embodiment of the invention.

FIG. 8 shows an example of a histogram shown on an LCD (liquid crystal display) of the digital camera according to the embodiment of the invention.

FIG. 9 is a block diagram illustrating an electrical configuration of the digital camera according to a second embodiment of the invention.

FIG. 10 is a diagram illustrating a circuitry of an imaging device of the digital camera according to the embodiment of the invention.

### DETAILED DESCRIPTION OF THE EMBODIMENT

Referring to the accompanying drawings, a digital camera according to an embodiment of the invention will be described in detail.

First Embodiment

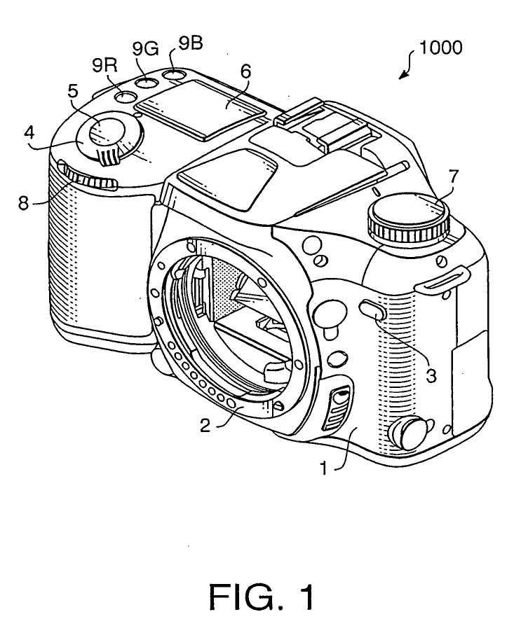

FIG. 1 is a perspective view showing a front appearance of a digital camera according to a first embodiment of the present invention. The digital camera 1000 is a digital SLR (single-lens reflex) camera having interchangeable lenses. On a front surface of the camera body 1 are provided with a lens mount 2, to which a photographing lens (not shown) is attached, and a white balance sensor 3, which is for receiving external light to evaluate color temperature. On a top surface of the camera body 1, a main switch 4 of a rotary lever, and a shutter button 5 to be pressed for releasing, an information LCD 6 for monitoring various information, and a mode dial 7 for setting various photographing modes are arranged. The shutter button 6 also functions as a photometry switch. In the vicinity of the shutter button 5 is arranged a front dial 8, which is rotated for adjusting exposure. Also on the top surface of the camera body 1, RGB adjust buttons 9R, 9G, and 9B for each RGB color.

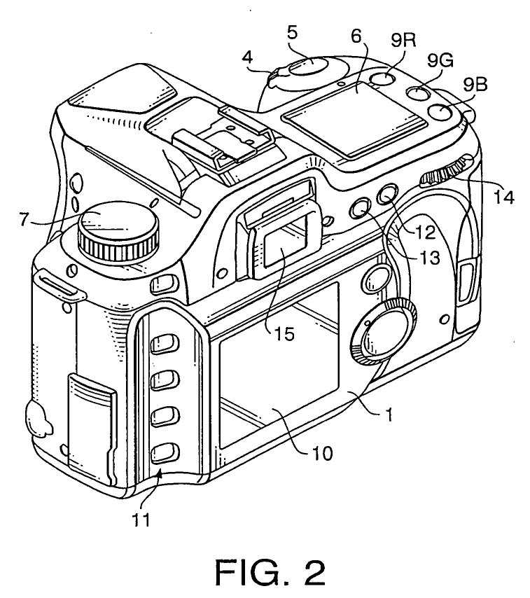

FIG. 2 is a perspective view showing a rear appearance of the digital camera according to an embodiment of the present invention. On a rear surface of the camera body 1 is provided with a main LCD 10 for displaying images captured and various information. Further, a plurality of mode buttons 11, an exposure adjust button 12, an AE (automatic exposure) lock button 13, a rear dial 14, and a finder 15 are provided. The mode buttons 11 are for various settings, and the exposure adjust button 12 is pressed for adjusting exposure. The AE lock button 13 is pressed for locking exposure. The rear dial 14 is rotated for adjusting each exposure of the RGB colors.

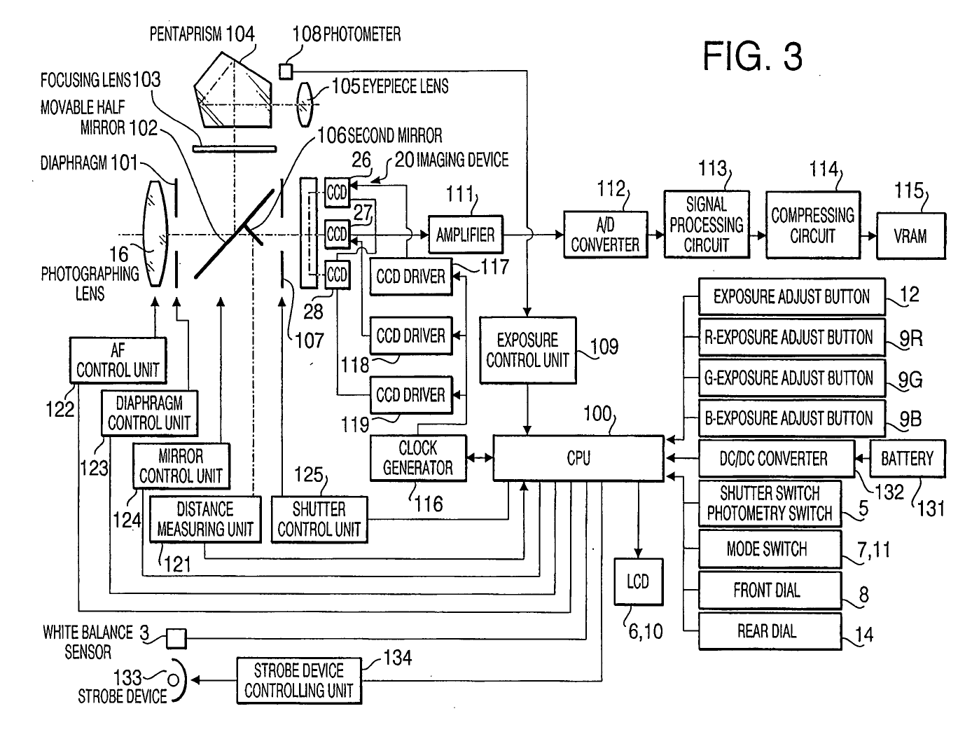

FIG. 3 is a block diagram illustrating an electrical configuration of the digital camera according to the embodiment of the invention. An image of an object formed through the photographing lens 16, which is attached to the lens mount 2, is passed through a diaphragm 101 and reflected in a movable half mirror 102, then formed on a focusing lens 103. The image formed on the focusing lens 103 is further reflected in a pentaprism 104 and can be observed through the eyepiece lens 105. The image passed through the movable half mirror 102 is further reflected by a second mirror 106, and received in a distance measuring unit 121, which evaluates distance to the object. The image is then transmitted through a shutter 107, which opens synchronously to the movable half mirror 102 when the movable half mirror 102 is uplifted. Finally, the image is received by an imaging device 20, wherein each of CCD (charge coupled device) element 26, 27, and 28 corresponding to each of the RGB color captures the image.

The captured signals for each color are amplified by an amplifier 111, and converted to digital image signals by an A/D (analog-to-digital) converter 112. To the digital image signals, color processing, such as a gamma processing and the like, is applied in a signal processing circuit 113. The processed image signals are then compressed by a compressing circuit 114 (or may not be compressed), and stored in a VRAM (video RAM) 115. A CPU 100 contains a clock generator 116. Storage time of electric charges in each CCD element 26, 27, and 28 can be individually set by a CPU 100 controlling R-CCD driver 117, G-CCD driver 118, and B-CCD driver 119 individually through a clock generator 116.

The CPU 100 uses output of a DC/DC converter 132, which uses DC/DC converted voltage of a battery 131, as a power source. When the image is captured, the CPU controls an AF (automatic focusing) control unit 122, which is provided inside the camera body 1, and a diaphragm control unit 123, which is provided inside the photographing lens 16. The CPU 100 further controls a mirror control unit 124 to operate the movable half mirror 102. The distance measuring unit 121 evaluates the distance to the object, and the CPU 100 controls the shutter control unit 125 to open/shut the shutter 107. The CPU 100 controls the information LCD 6 to display various information for photographing and the main LCD 10 to display captured images. The CPU 100 also controls a strobe device controlling unit 134, which controls the strobe device 133 to emit light.

The CPU 100 stores color temperature information evaluated by the white balance sensor 3 and exposure information calculated by an exposure control unit 109 based on the evaluated value of a photometer 108, which is arranged in the vicinity of the eyepiece lens 105, in a ROM equipped to the CPU 100. Further, the CPU 100 stores switch status information of the photometry switch and the release switch of the shutter button 5. The CPU 100 is also provided with mode information that is inputted with mode setting members, for example the mode dial 7 and the mode buttons 11. Furthermore, the CPU stores information concerning the exposure adjust button 12, when the exposure adjust button 12 is pressed, and information concerning exposure for each of the RGB colors, when any of the RGB adjust buttons 9R, 9G, and 9B is pressed. The CPU 100 also stores information from the front dial 8 and the rear dial 14 when front dial 8 and the rear dial 14 are rotated.

The imaging device 20 converts the image of the object through the photographing lens 16 into digital signals. In the present embodiment, the imaging device 20 is configured to be a triple-CCD.

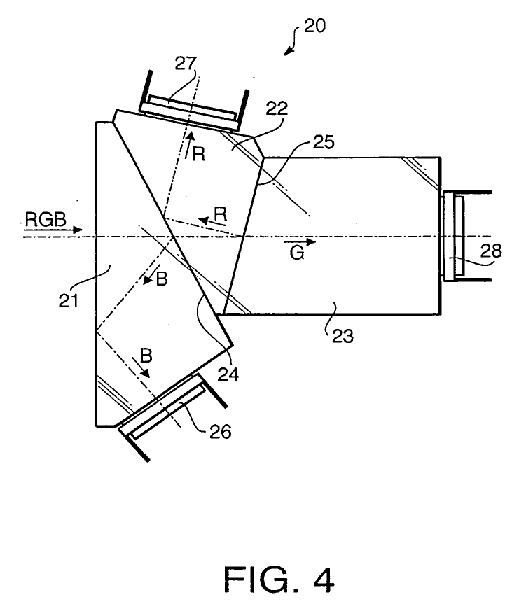

FIG. 4 shows a diagram illustrating a configuration of the imaging device 20 of the digital camera according to the embodiment of the invention. On an optical axis of the photographing lens 16 is provided a dichroic prism, which includes three prisms. Each prism of the three prisms is hereinafter referred to as a B-prism 21, R-prism 22, and G-prism 23, respectively. The B-prism 21, the R-prism 22, and the G-prism 23 are formed with transparent resin or glass. The B-prism 21 is coated with B reflective dichroic filter 24 that reflects blue light in a side direction, and the R-prism 22 is coated with R reflective dichroic filter 25 that reflects red light in another side direction. The G-prism 23 is not provided with reflective dichroic filter, and green light entered in the G-prism 23 is transmitted to the back of the G-prism 23. An end surface of each prism is provided with a CCD element, i.e., an end surface of the B-prism 21 is provided with a CCD element (hereinafter referred to as a B-CCD 26), and end an surface of the R-prism 22 is provided with an R-CCD 27, and an end surface of the G-prism 23 is provided with a G-CCD 28.

As shown in the arrows and the dotted lines in FIG. 4, the light of the object image is entered through the photographing lens 16, and the blue light is reflected by the reflective dichroic filter B and received by the B-CCD 26. Similarly, the red light is reflected by the reflective dichroic filter R and received by the R-CCD 27. The green light is transmitted through the G-prism 23, and received by the G-CCD 28. Thus, the light of the object image is resolved into three colors, which are red, green, and blue, and received by the respective CCD, and output as digital signals corresponding to each color.

Methods to adjust exposure and white balance will be described below.

Adjusting exposure is conducted in a known method. That is, when the exposure adjust button 12 is pressed, the CPU 100 enters an exposure adjusting mode. In the exposure adjusting mode, when the front dial 8 is rotated, the CPU 100 drives controlling units, for example the diaphragm control unit 123 and the shutter control unit 125, to adjust exposure for amount corresponding to the rotation of the front dial 8 and controls the light of the object image that reaches to the imaging device 20. Thus, the amount of electric charges to be stored in each of the RGB-CCDs 26, 27, and 28 is controlled, and signal levels to be output from the imaging device 20 is adjusted.

Adjusting white balance is conducted based on setting of a white balance mode with the front dial 8 and the mode buttons 11. In this embodiment, automatic white balance mode, preset white balance mode, and manual white balance mode are provided as the white balance mode.

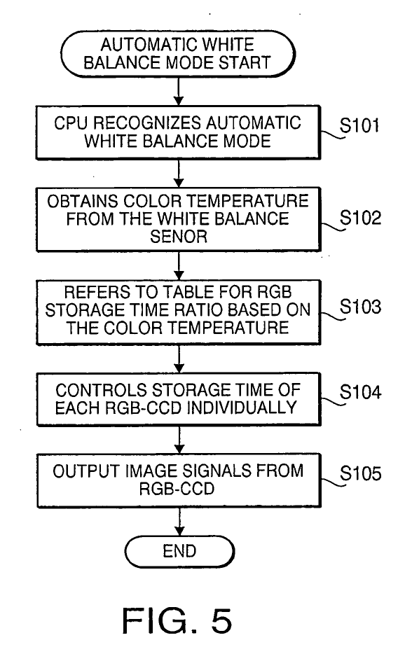

In the automatic white balance mode, the white balance is adjusted based on the color temperature of a light source that is evaluated by the white balance sensor 3. The automatic white balance mode starts when the user specifies the mode by operating the mode dial 7. In S101, as seen in the flowchart in FIG. 5, the CPU 100 recognizes the white balance mode is the automatic white balance mode. In S102, the CPU 100 obtains the evaluated color temperature of the light source from the white balance sensor 3. In S103, the CPU 100 refers to a reference table, which has been created and stored in a memory, based on the color temperature. The reference table contains ratios of storage times for electric charges corresponding to each color component to be stored in the RGB-CCDs 26, 27, and 28. In S104, the CPU 100 controls the storage time for each of the RGB-CCDs 26, 27, and 28 individually. In S105, each of the RGB-CCDs 26, 27, and 28 respectively output image signals. With the above process, the image signals obtained from the R-CCD 27, G-CCD 28, and B-CCD 26 are processed by some of the units, for example the signal processing circuit 113, and the output image is represented to be adjusted to the color temperature of the light source.

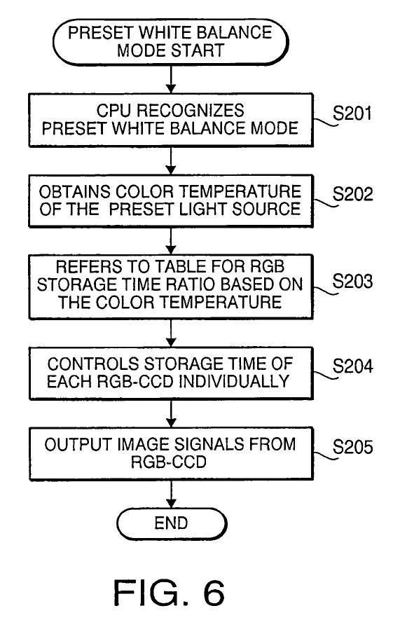

In the preset white balance mode, the white balance is adjusted based on a setting selected by the user among different preset color temperature settings depending on color temperatures of light sources, which are for example a filament lamp, a fluorescent lamp, and the sun. FIG. 6 is a flowchart illustrating the preset white balance adjusting operation of the digital camera according to the embodiment of the invention. In S201, the CPU 100 recognizes the white balance mode is in the preset white balance mode. In S202, the CPU 100 obtains the color temperature of the light sources that is specified by an operation of the user with the front dial 8 and the mode buttons 11. In S203, the CPU 100 refers to the reference table, which has been created and stored in a memory, for a ratio of storage time for charges to be stored in each of the RGB-CCDs 26, 27, and 28 based on the color temperature. In S204, the CPU 100 controls the storage time for each of the RGB-CCDs 26, 27, and 28 individually, similarly to S104 in the automatic white balance mode. In S205, each of the RGB-CCDs 26, 27, and 28 respectively output image signals. With the above process, the output image is represented to be adjusted to the color temperature of the light source.

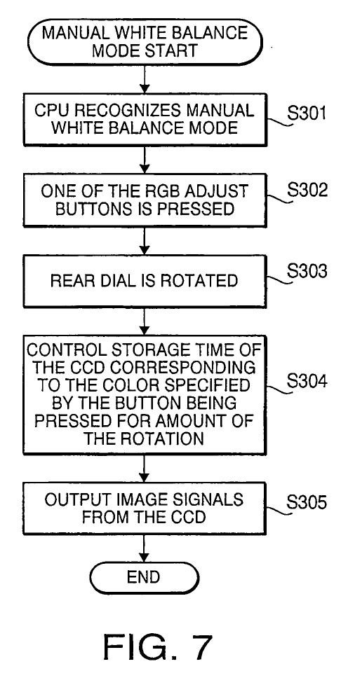

In the manual white balance mode, the white balance is adjusted manually by the user operating the front dial 8 and the mode buttons 11. FIG. 7 is a flowchart illustrating a manual white balance adjusting operation of the digital camera according to the embodiment of the invention. In S301, the CPU 100 recognizes the white balance mode is in the manual white balance mode. In S302, the CPU 100 obtains information indicating any of the RGB adjust buttons 9R, 9G, and 9B has been pressed. In S303, the CPU further obtains information indicating that the rear dial 14 has been rotated. In S304, the CPU controls the storage time of the CCD that corresponds to the color specified by the button being pressed for the amount corresponding to the rotation of the rear dial 14. For another color components, the CPU repeats S302, S303, and S304. In S305, each of the RGB-CCDs 26, 27, and 28 respectively output image signals. With the above process, the output image is represented to be in the white balance adjusted manually.

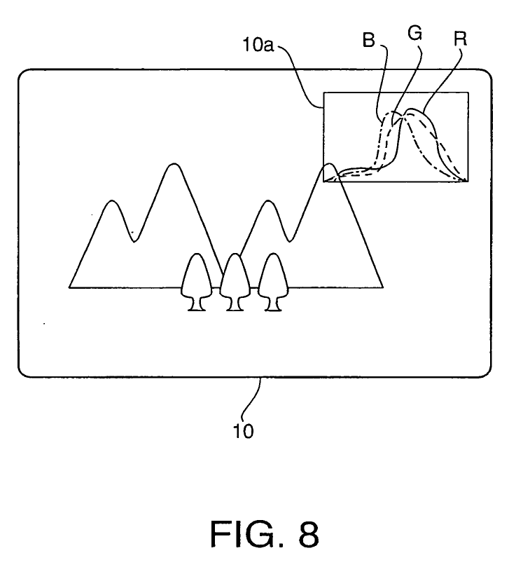

When the white balance is adjusted manually, a histogram window 10a to indicate the spectral distribution of the RGB may be shown on the main LCD 10. FIG. 8 shows an example of the histogram overlaid on the main LCD of the digital camera according to the embodiment of the invention. With this configuration, the user is allowed to view the histogram of each RGB that corresponds to the rotation amount of the rear dial 14, and to adjust the white balance for desired amount. Thus, noise to color signals that is conventionally increased by increasing gain values can be limited even when the white balance is manually adjusted.

Second Embodiment

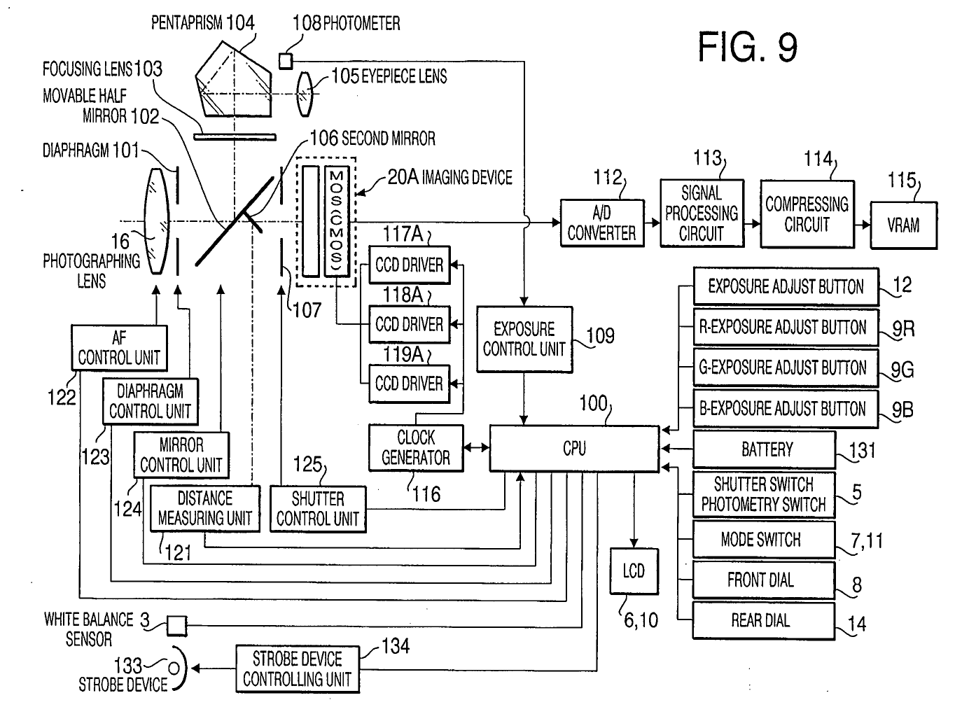

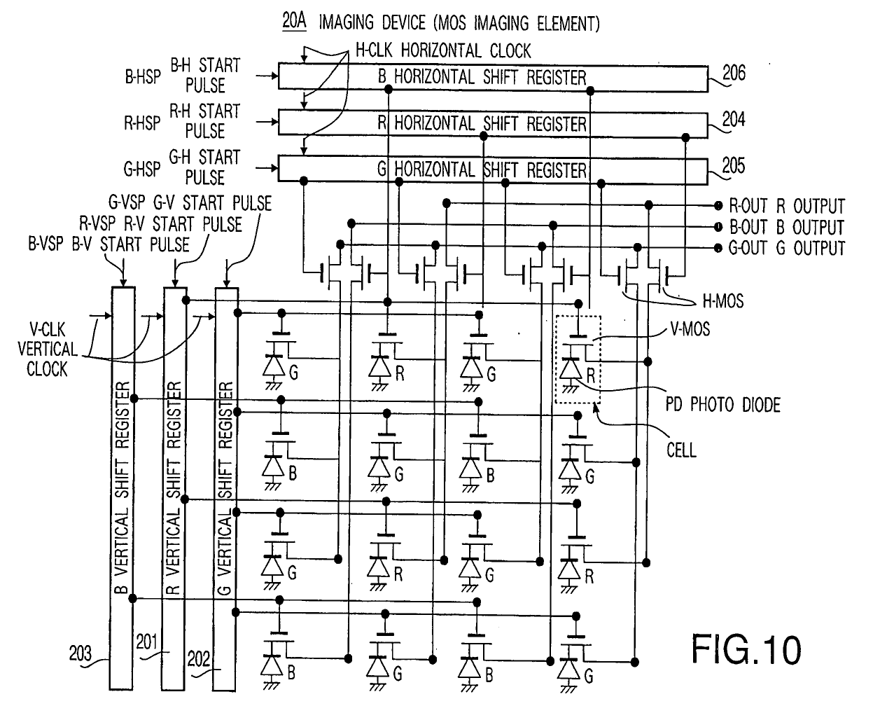

FIG. 9 is a block diagram illustrating an electrical configuration of a digital camera according to a second embodiment of the invention. An appearance of the digital camera in the second embodiment is similar to the appearance shown in the first embodiment (see FIGS. 1 and 2). In this embodiment, the configuration corresponding to the configuration of the first embodiment is referred to by the same reference numbers, and description of those are omitted. In the second embodiment, an imaging device 20A includes a single MOS (CMOS: Complementary Metal-Oxide Semiconductor). FIG. 10 is a diagram illustrating a circuitry of an imaging device of the digital camera according to the embodiment of the invention. In the MOS, each photo receiving cell CELL includes a photo diode PD and a vertical transistor (i.e., a V-MOS) as a switching device to output the electric charges stored in the photo diode PD, and a plurality of the photo receiving cells CELL are aligned in matrix. In a photo receiving path of each photo diode PD is inserted any one of red color filter, green color filter, and blue color filter (not shown). With these filters, each photo receiving cell CELL is assigned to receive and capture the corresponding color of light. In this embodiment, adjoining four photo receiving cells CELL, which are two green receiving cells (hereinafter referred to as G-cells), one red receiving cell (hereinafter referred to as R-cell), and one of blue receiving cell (hereinafter referred to as B-cell), are configured to be in a unit, and a plurality of units are aligned in matrix.

Gates of the V-MOSes are respectively connected to each of R-vertical shift register 201, G-vertical shift register 202, and B-vertical shift register 203. The gates are opened and each of the photo receiving cells corresponding to each color component are vertically sequentially selected and activated based on vertical start pulses R-VSP, G-VSP, and B-VSP, which are supplied to each vertical RGB shift register 201, 202, and 203, in synchronization to a vertical clock V-CLK. Thus, each photo receiving cell CELL stores the electric charges generated by the photo diode PD during a period since the V-MOS is turned off and until the V-MOS is turned on again. Drains of each V-MOS are respectively connected to outputs for each color R-OUT, G-OUT, and B-OUT through horizontal transistors H-MOSes. Gates of the H-MOSes are respectively connected to each of R-horizontal shift register 204, G-horizontal shift register 205, and B-horizontal shift register 206. The gates are opened and each of the photo receiving cells corresponding to each color component are horizontally sequentially selected and activated based on horizontal start pulses R-HSP, G-HSP, and B-HSP, which are supplied to each RGB horizontal shift register 204, 205, and 206, in synchronization to the horizontal clock H-CLK.

The vertical and horizontal RGB shift registers 201-206 are controlled respectively by R-MOS driver 117A, G-MOS driver 118A, and B-MOS driver 119A, which are controlled by the clock generated by the clock generator 116. The CPU 100 controls the RGB-MOS drivers 117A, 118A, and 119A based on the white balance mode set by the user with the front dial 8 and the mode buttons 11.

As described above, the timing to activate the V-MOSes of each RGB receiving cells can be controlled by controlling the RGB vertical shift registers 201, 202, and 203. Thus, the storage time for electric charges in the photo diodes PD in each cell can be controlled. Therefore, when the timing to activate the V-MOSes is delayed, the storage time of the photo diodes PD becomes longer, and when the timing to activate the V-MOSes is forwarded, the storage time becomes shorter. The timing can be adjusted independently for R, G and B, by each of the RGB shift registers 201, 202, and 203, therefore, the storage time for the photo receiving cells of one color does not affect to the storage time of the photo receiving cells of another colors. Thus, noise to color signals output from the V-MOSes can be controlled without increasing noise levels.

It should be noted that, also in the second embodiment, the white balance can be adjusted following any of the processes shown in the flowcharts in FIGS. 5-7 based on the mode, which is one of the automatic white balance mode, the preset white balance mode, and the manual white balance mode, set by the user, similarly to the first embodiment. However, it should be noted in the second embodiment, for controlling the storage time of each image signal for each RGB color, the storage time of each V-MOS for each RGB color is independently controlled. Also it should be noted that, the CCD in FIGS. 5-7 in the first embodiment is respectively replaced with MOS. With this configuration, the noise to color signals that is conventionally increased by increasing gain values can be limited even when the white balance is manually adjusted, and images with appropriate white balance can be obtained. It should be noted in the second embodiment that the imaging device includes one imaging element, thus, it is advantageous to provide a downsized digital camera and to reduce production cost.

In the above-described embodiments, the white balance is adjusted in the manual white balance mode by pressing any one of the RGB adjust buttons 9R, 9G, and 9B to specify the color components to be adjusted and simultaneously rotating the rear dial 14. However, the invention is not limited to such configuration. The color components to be adjusted may be specified by pressing one exposure adjust button sequentially to switch from one of the RGB to another. In this case, one exposure adjust button is required, and three of the RGB adjust buttons 9R, 9G, and 9B may not be required, therefore, the number of buttons required for the camera may be reduced. Optionally, the color components to be adjusted may be specified by operations to one dial, or by operations based on a display shown on one of the LCDs. It should be noted the arrangement of the RGB prisms 21, 22, and 23 of the imaging device 20 is not limited to the arrangement described in the first embodiment. The G-prism 23 may be provided with a reflective dichroic filter and arranged to the upfront, or the R-prism 22 may be arranged to the upfront.

The present disclosure relates to the subject matter contained in Japanese Patent Application No. 2004-323177, filed on Nov. 8, 2004, which is expressly incorporated herein by reference in its entirety.

What is claimed is:

1. A digital camera comprising:
an imaging device, which is adapted to store electric charges for each color component of a plurality of color components from an object image and outputs image signals corresponding to the object image; and
a storage time controlling system, which is adapted to control length of storage time of the electric charges for each color component independently.

2. The digital camera according to claim 1, wherein the plurality of color components are three primary colors of light.

3. The digital camera according to claim 2,
wherein the imaging device includes a plurality of imaging elements, each of which is adapted to receive each color component respectively, and
the storage time controlling system is adapted to control the length of the storage time of the electric charges for each of the imaging elements.

4. The digital camera according to claim 3,
wherein the imaging device is a triple panel imaging device, which includes an optical system to resolve the object image into the plurality of color components, and three imaging elements, each of which is adapted to receive each color component of the resolved plurality of color components.

5. The digital camera according to claim 4, wherein the imaging element is a charge coupled device.

6. The digital camera according to claim 2,
wherein the imaging device includes a plurality of photo receiving cells, each of which includes a photo receiving element and a switching element, each of the photo receiving cells receives each color component, and
the length of the storage time of the electric charges for each color component is controlled independently by the storage time controlling system.

7. The digital camera according to claim 6, wherein the photo receiving cell is a metal-oxide semiconductor.

8. The digital camera according to claim 7,
wherein the imaging device includes a vertical driving system, which is adapted to select and drive the photo receiving cells that are assigned to each color component, and a horizontal driving system, which is adapted to obtain the imaging signals corresponding to each color component.

9. The digital camera according to claim 2, comprising a sensor, which is adapted to evaluate a color temperature of an external light,
wherein the storage time controlling system is adapted to control the length of the storage time of the electric charges for each color component based on the color temperature evaluated by the sensor.

10. The digital camera according to claim 2,
wherein the storage time controlling system is adapted to control the length of the storage time of the electric charges for each color component to be a predetermined length of storage time corresponding to each of a plurality of light sources with different color temperatures.

11. The digital camera according to claim 2, comprising at least one of a first operating member, which is adapted to specify a color component to be adjusted,
wherein the storage time controlling system is adapted to control the length of the storage time of the electric charges for the color component specified by the first operating member.

12. The digital camera according to claim 11, comprising a second operating member, which is adapted to set the length of the storage time of the electric charges when the color component to be adjusted is specified by the first operating member.

13. A digital camera comprising:
an imaging device, which is adapted to store electric charges for each color component of a plurality of color components from an object image and outputs image signals corresponding to the object image; and
a storage time controlling system, which is adapted to arbitrarily control length of storage time of the electric charges for each of the plurality of color components independently based on operations from a user.

14. The digital camera according to claim 13, wherein the plurality of color components are three primary colors of light.

15. The digital camera according to claim 14,
wherein the imaging device includes a plurality of imaging elements, each of which is adapted to receive each color component respectively, and
the storage time controlling system is adapted to control the length of the storage time of the electric charges for each of the imaging elements.

16. The digital camera according to claim 15,
wherein the imaging device is a triple panel imaging device, which includes an optical system to resolve the object image into the plurality of color components, and three imaging elements, each of which is adapted to receive each color component of the resolved plurality of color components.

17. The digital camera according to claim 16, wherein the imaging element is a charge coupled device.

18. The digital camera according to claim 14,
wherein the imaging device includes a plurality of photo receiving cells, each of which includes a photo receiving element and a switching element, each of the photo receiving cells receives each color component, and
the length of the storage time of the electric charges for each color component is controlled independently by the storage time controlling system.

19. The digital camera according to claim 18, wherein the photo receiving cell is a metal-oxide semiconductor.

20. The digital camera according to claim 19,
wherein the imaging device includes a vertical driving system, which is adapted to select and drive the photo receiving cells that are assigned to each color component, and a horizontal driving system, which is adapted to obtain the imaging signals corresponding to each color component.

21. The digital camera according to claim 14, comprising at least one of a first operating member, which is adapted to be operated by the user and to specify a color component to be adjusted,
wherein the storage time controlling system is adapted to control the length of the storage time of the electric charges for the color component specified by the first operating member.

22. The digital camera according to claim 21, comprising a second operating member, which is adapted to be operated by the user and to set the length of the storage time of the electric charges when the color component to be adjusted is specified by the first operating member.

23. A digital camera comprising:
a sensor, which is adapted to obtain a color temperature of an external light,
an imaging device, which is adapted to store electric charges for each color component of a plurality of color components from an object image and outputs image signals corresponding to the object image; and
a storage time controlling system, which is adapted to control length of storage time of the electric charges for each of the plurality of color components independently based on the color temperature of the object image obtained from the sensor so that a white balance of the object image is controlled.

24. The digital camera according to claim 23, wherein the plurality of color components are three primary colors of light.

25. The digital camera according to claim 24,
wherein the imaging device includes a plurality of imaging elements, each of which is adapted to receive each color component respectively, and
the storage time controlling system is adapted to control the length of the storage time of the electric charges for each of the imaging elements.

26. The digital camera according to claim 25,
wherein the imaging device is a triple panel imaging device, which includes an optical system to resolve the object image into the plurality of color components, and three imaging elements, each of which is adapted to receive each color component of the resolved plurality of color components.

27. The digital camera according to claim 26, wherein the imaging element is a charge coupled device.

28. The digital camera according to claim 24,
wherein the imaging device includes a plurality of photo receiving cells, each of which includes a photo receiving element and a switching element, each of the photo receiving cells receives each color component, and
the length of the storage time of the electric charges for each color component is controlled independently by the storage time controlling system.

29. The digital camera according to claim 28, wherein the photo receiving cell is a metal-oxide semiconductor.

30. The digital camera according to claim 29,
wherein the imaging device includes a vertical driving system, which is adapted to select and drive the photo receiving cells that are assigned to each color component, and a horizontal driving system, which is adapted to obtain the imaging signals corresponding to each color component.

31. The digital camera according to claim 24,
wherein the storage time controlling system is adapted to control the length of the storage time of the electric charges for each color component to be a predetermined length of storage time corresponding to each of a plurality of light sources with different color temperatures.

32. A method for a using digital camera having an imaging device, which is adapted to store electric charges for each color component of a plurality of color components from an object image and output image signals corresponding to the object image, to control length of storage time of the electric charges for each color component independently.

33. A program product comprising instructions to use a digital camera having an imaging device, which is adapted to store electric charges for each color component of a plurality of color components from an object image and output image signals corresponding to the object image, to control length of storage time of the electric charges for each color component independently.
